(19) United States
(12) Patent Application Publication
(10) Pub. No.: US 2008/0242576 A1
(43) Pub. Date: Oct. 2, 2008

(54) Probe cleaning sheet

(76) Inventors: Jun Tamura, Tokyo (JP); Toshihiro Kobayashi, Tokyo (JP); Jun Watanabe, Tokyo (JP)

Correspondence Address: BEYER WEAVER LLP, P.O. BOX 70250, OAKLAND, CA, 94612-0250, US

(21) Appl. No.: 11/890,291

(22) Filed: Aug. 3, 2007

(30) Foreign Application Priority Data
Aug. 9, 2006 (JP) 2006-217499

(51) Int. Cl. C11D 17/00

(52) U.S. Cl. 510/179

(57) ABSTRACT

A probe cleaning sheet for removing foreign objects attached to tip part of a probe is formed with a plastic sheet having a flat and even surface and a uniform thickness and a cleaning layer with a flat and even surface and a uniform thickness formed on the surface of this plastic sheet. The cleaning layer has viscoelastic properties. Its Young's modulus is 30 MPa or more and 700 MPa les less, its storage modulus at 25° C. is 1.2×10⁸ dyn/cm² or more and 1.2×10⁹ dyn/cm² or less, and the value of its storage modulus at 25° C. is 1.2 or more and 3.0 or less times the value of its storage modulus at 150° C.

This application claims priority on Japanese Patent Application 2006-217499 filed Aug. 9, 2006.

### BACKGROUND OF THE INVENTION

This invention relates to a probe cleaning sheet for removing foreign objects attached to the tip part of a probe that is used for the inspection of electrical characteristics in the inspection process for semiconductor devices.

In order to improve the production efficiency in the production process for semiconductor devices, a probe is used to contact electrode pads of a plurality of chips formed on a semiconductor wafer for inspecting the electrical characteristics of each chip by applying and detecting test signals through this probe.

In general, such a probe is made of a hard material such as tungsten and beryllium, while the electrode pads are made of a relatively soft material such as aluminum. When the probe is made to contact an electrode pad, foreign objects such as aluminum of the electrode pad become attached to the tip part (the tip and the side surfaces near the tip) of the probe, and this affects the accuracy of the inspection adversely. If a large foreign object is attached to a probe, mutually adjacent probes may become shorted, causing chips to be destroyed. For this reason, the tip part of the probe is cleaned for removing the foreign objects.

As disclosed in Japanese Patent Publications Tokkai 7-244074 and 2004-140013, for example, the tip part of a probe may be cleaned by attaching a probe cleaning sheet to the surface of a table and causing the tip part of the probe to penetrate into the interior of this sheet from its surface. It has been known to use a sheet of an elastic material such as silicon rubber and urethane rubber with abrading particles (such as hard particles of aluminum oxide, silicon carbide and diamond) mixed in as the probe cleaning sheet. As disclosed in Japanese Patent Publication Tokuhyo 2005-515645, probe cleaning sheets having a sticky gel layer formed on the surface of a plate with minute unevenness prepared thereon have also been used. After the tip part of the probe penetrates the interior of the gel layer from its surface, the probe is moved while its tip remains in contact with the unevenness of the surface of the plate such that the tip part becomes cleaned.

As the chip size is made smaller in recent years, the electrode pads formed on the chips are becoming smaller and the electrode pads are coming to be formed closer to one another. For this reason, it is becoming necessary to make the probes thin, and relatively soft materials having an improved electrical characteristics such as beryllium-copper alloys are coming to be used to form the probes.

If a conventional probe cleaning sheet as described above is used on such a probe, however, the probe is easily worn down by the cleaning process, adversely affecting the useful lifetime of the probe. The worn condition of a probe also gives rise to the problem of inspection errors on the electrical characteristics of the chips.

Moreover, the inspection of electrical characteristics of a chip must be carried out under an approximately same environmental condition as where the chip is actually used (in a temperature range from normal temperature of about 25° C. to about 150° C. if the chip is to be mounted to an automobile). Since the cleaning of the probe is also carried out under the environmental condition of the inspection of the chips, the cleaning sheet is required to have a sufficient cleaning characteristic under nearly same environmental conditions.

### SUMMARY OF THE INVENTION

It is therefore an object of this invention to provide a cleaning sheet that will not easily wear down a probe and has a sufficient cleaning characteristic under an environmental condition which is nearly the same as that under which chips are used, or within the range of temperature from about 25° C. to about 150° C.

This invention relates to a probe cleaning sheet for removing foreign objects attached to the tip part of a probe. In view of the object described above, the probe cleaning sheet of this invention is characterized as comprising a plastic sheet having a flat and even surface and a uniform thickness and a cleaning layer formed on the surface of this plastic sheet, the cleaning layer having a flat and even surface and a uniform thickness, and this cleaning layer having viscoelastic properties.

As preferable viscoelastic properties, the cleaning layer has Young's modulus of 30 MPa or more and 700 MPa les less, storage modulus at 25° C. of 1.2×10⁸ dyn/cm² or more and 1.2×10⁹ dyn/cm² or less, and value of storage modulus at 25° C. 1.2 or more and 3.0 or less times the value of storage modulus at 150° C. More preferably, the cleaning layer may have Young's modulus of 80 MPa or more and 400 MPa or less, storage modulus at 25° C. of 1.5×10⁸ dyn/cm² or more and 8.0×10⁸ dyn/cm² or less, and value of storage modulus at 25° C. 1.4 or more and 2.4 or less times the value of storage modulus at 150° C.

The cleaning layer may comprise silicon rubber and may have thickness of 50 μm or more and 300 μm or less. The plastic sheet may have thickness of 50 μm or more and 188 μm or less and thermal shrinkage ratio of 2% within the range of 25° C. or more and 150° C. or less.

As a practical example, a layer of adhesive agent may be formed on a back surface of the plastic sheet such that a peelable paper sheet is pasted on the surface of this layer of adhesive agent. This paper sheet is removed from the surface of the adhesive agent and the probe cleaning sheet of this invention is pasted through this adhesive agent on a table when a probe is cleaned.

With a probe cleaning sheet thus structured, a probe can be cleaned easily and effectively without wearing down excessively in an environmental condition approximately equal to that of using the probe (within the range of 25° C. to 150° C.).

### BRIEF DESCRIPTION OF THE DRAWINGS

FIG. 1 is a schematic sectional view of a probe cleaning sheet of this invention.

FIG. 2 is a microscopic photograph of a sectional surface of a probe cleaning sheet of this invention.

FIG. 3 is a sketch of a probe cleaning apparatus.

### DETAILED DESCRIPTION OF THE INVENTION

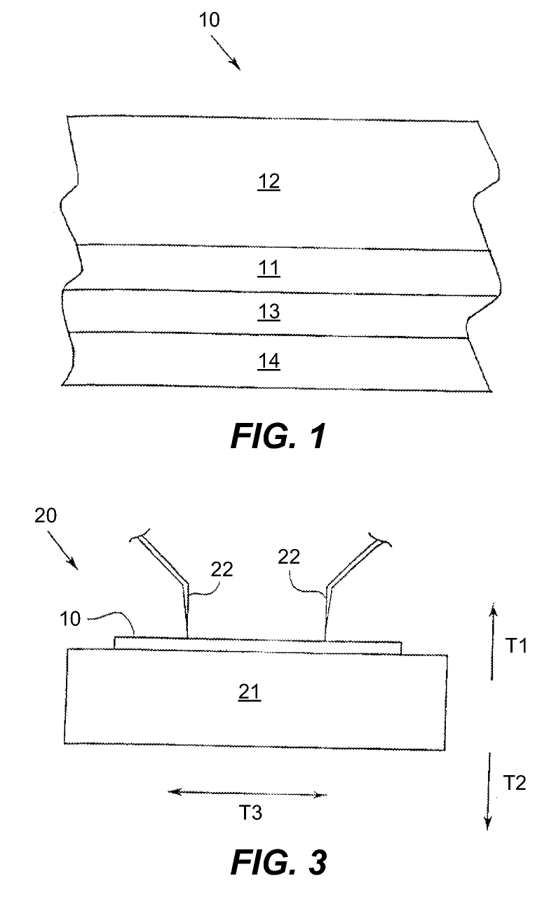

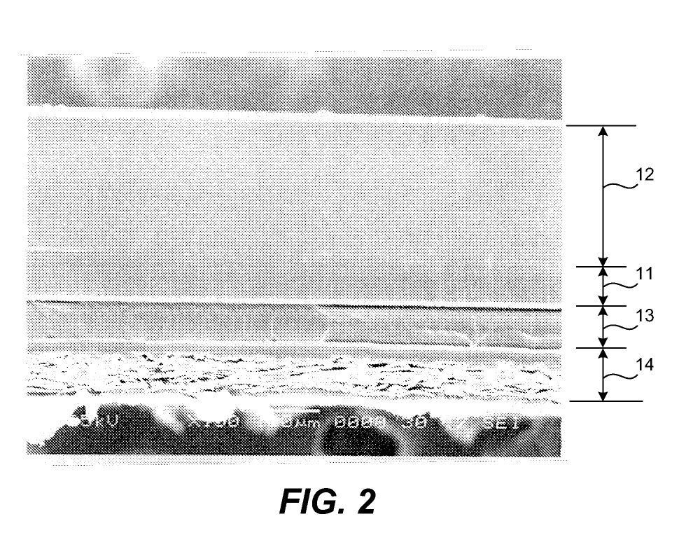

As shown in FIGS. 1 and 2, a probe cleaning sheet 10 of this invention for removing foreign objects attached to the tip part of a probe comprises a plastic sheet 11 having flat and even surface and a uniform thickness and a cleaning layer 12 formed on the surface of this plastic sheet 11.

The cleaning layer 12 has a flat and even surface and its thickness is uniform. It has viscoelastic properties, having Young's modulus in the range of 30 MPa or more and 700 MPa or less. Its storage modulus at 25° C. is in the range of 1.2×10⁸ dyn/cm² or more and 1.2×10⁹ dyn/cm² or less. The value of its storage modulus at 25° C. is preferably 1.2 or more times and 3.0 or less times that at 150° C.

It is more preferable that the Young's modulus of the cleaning layer 12 be within the range of 80 MPa or more and 400 MPa or less, its storage modulus at 25° C. be in the range of 1.5×10⁸ dyn/cm² or more and 8.0×10⁸ dyn/cm² or less and the value of its storage modulus at 25° C. be 1.4 or more times and 2.4 or less times that at 150° C.

The cleaning layer 12 is a uniform layer, not having any openings inside such as a foamed layer but being a uniformly filled viscoelastic layer and may preferably comprise silicon rubber.

The invention does not impose any particular limitation regarding the thickness of the cleaning layer 12. It is sufficient if it is more than the length of the tip part of the probe to be cleaned. It may be within the range of 50 μm or more and 300 μm or less.

For the plastic sheet 11, a material with a small thermal deformation is preferable. A material with the thermal shrinkage as mechanical characteristic of less than 2% within the range of 25° C. or more and 150° C. or less and with thickness within the range of 50 μm or more and 188 μm or less is used. The invention does not impose any particular limitation regarding its size or material. A sheet made of polypropylene, polyethylene, polyethylene terephthalate (PET), polyurethane, acryl, polyvinyl chloride, vinilon or rayon may be used. Of the above a PET sheet is preferable.

As shown in FIGS. 1 and 2, a layer of an adhesive agent (hereinafter referred to as the adhesive layer 13) may be formed on the back surface of the plastic sheet 11, and a peeling sheet of paper 14 may be pasted on the surface of this adhesive layer 13. After this peeling sheet 14 is peeled off from the surface of the adhesive layer 13, the probe cleaning sheet 10 of this invention may be attached on the table (shown at 21 of FIG. 3) of a probe cleaning apparatus (shown at 20 in FIG. 3). The adhesive layer 13 may be formed by coating the back surface of the plastic sheet 11 with a commonly available adhesive agent of acryl, silicon or epoxy type. An adhesive agent of this kind that does not carbonize or gelify (or become dissolved) at 150° C. is used. As a practical matter, the probe cleaning sheet may be pasted onto a table through the adhesive layer 13 but it may also be vacuum-adsorbed to the table. If it is to be vacuum-adsorbed to the table, the adhesive layer 13 need not be formed on the back surface of the plastic sheet 11.

As shown in FIG. 3, the probe cleaning sheet 10 of this invention is pasted on the surface of a table 21 through the adhesive layer 13. The tip part of a probe 22 is placed on the surface of the cleaning layer 12 of the sheet 10, the table 21 is moved in the direction of arrow T1, and the tip portion of the probe 22 is thrust into the cleaning layer 12. The table 21 is then caused to move reciprocatingly in the directions of arrows T1 and T2 with the tip part of the probe 22 remaining in this penetrating condition inside the cleaning layer 12 such that foreign objects attached to the tip part of the probe 22 are wiped off and removed away.

Instead of such a reciprocating motion as described above, the table 21 or the probe 22 may be moved in the direction of arrow T3 parallel to the surface of the sheet 10 with the tip part of the probe 22 remaining in this penetrating condition inside the cleaning layer 12 such that foreign objects attached to the tip part of the probe 22 are wiped off and removed away.

The invention is described next by way of Test Examples.

### TEST EXAMPLE 1

Probe cleaning sheet of Test Example 1 was prepared as follows. The materials for the probe cleaning sheet of Test Example 1 are shown in Table 1, and the physical properties of the probe cleaning sheet of Test Example 1 are shown in Table 2 below.

TABLE 1

| | Material | Thickness (μm) |
|---|---|---|
| Cleaning layer | Silicon rubber | 212.0 |
| Plastic sheet | PET sheet | 80.0 |
| Adhesive layer | Acryl adhesive | 64.0 |
| Peelable paper sheet | Paper | 89.3 |

The probe cleaning sheet of Test Example 1 was produced by coating the surface of a PET sheet with silicon rubber with physical characteristics shown in Table 2 to a thickness of 300 μm. An acryl adhesive was applied to the back surface of this PET sheet to form the adhesive layer, and a peelable paper sheet was pasted onto this adhesive layer.

### TEST EXAMPLE 2

Probe cleaning sheet of Test Example 2 was prepared. The materials used for the production were as shown in Table 1. The viscoelastic properties of the probe cleaning sheet of Test Example 2 are shown in Table 2 below. As done in Test Example 1, the surface of a PET sheet was coated with silicon rubber with viscoelastic properties as shown in Table 2 to a thickness of 300 μm. An acryl adhesive was applied to the back surface of this PET sheet to form the adhesive layer, and a peelable paper sheet was pasted onto this adhesive layer.

### TEST EXAMPLE 3

Probe cleaning sheet of Test Example 3 was prepared. The materials used for the production were as shown in Table 1. The viscoelastic properties of the probe cleaning sheet of Test Example 3 are shown in Table 2 below. As done in Test Example 1, the surface of a PET sheet was coated with silicon rubber with viscoelastic properties as shown in Table 2 to a thickness of 300 μm. An acryl adhesive was applied to the back surface of this PET sheet to form the adhesive layer, and a peelable paper sheet was pasted onto this adhesive layer.

### TEST EXAMPLE 4

Probe cleaning sheet of Test Example 4 was prepared. The materials used for the production were as shown in Table 1. The viscoelastic properties of the probe cleaning sheet of Test Example 4 are shown in Table 2 below. As done in Test Example 1, the surface of a PET sheet was coated with silicon rubber with viscoelastic properties as shown in Table 2 to a thickness of 300 μm. An acryl adhesive was applied to the back surface of this PET sheet to form the adhesive layer, and a peelable paper sheet was pasted onto this adhesive layer.

### TEST EXAMPLE 5

Probe cleaning sheet of Test Example 5 was prepared. The materials used for the production were as shown in Table 1. The viscoelastic properties of the probe cleaning sheet of Test Example 5 are shown in Table 2 below. As done in Test Example 1, the surface of a PET sheet was coated with silicon rubber with viscoelastic properties as shown in Table 2 to a thickness of 300 μm. An acryl adhesive was applied to the back surface of this PET sheet to form the adhesive layer, and a peelable paper sheet was pasted onto this adhesive layer.

### COMPARISON EXAMPLE 1

Probe cleaning sheet of Comparison Example 1 was prepared. The materials used for the production were as shown in Table 1. The viscoelastic properties of the probe cleaning sheet of Comparison Example 1 are shown in Table 2 below. As done in Test Example 1, the surface of a PET sheet was coated with silicon rubber with viscoelastic properties as shown in Table 2 to a thickness of 300 μm. An acryl adhesive was applied to the back surface of this PET sheet to form the adhesive layer, and a peelable paper sheet was pasted onto this adhesive layer.

### COMPARISON EXAMPLE 2

Probe cleaning sheet of Comparison Example 2 was prepared. The materials used for the production were as shown in Table 1. The viscoelastic properties of the probe cleaning sheet of Comparison Example 2 are shown in Table 2 below. As done in Test Example 1, the surface of a PET sheet was coated with silicon rubber with viscoelastic properties as shown in Table 2 to a thickness of 300 μm. An acryl adhesive was applied to the back surface of this PET sheet to form the adhesive layer, and a peelable paper sheet was pasted onto this adhesive layer.

TABLE 2

| | Young's | Storage modulus | |
|---|---|---|---|
| | modulus | (E′(25°)) | E′(25°)/ |
| | (MPa) | (dyn/cm²) | ′E′(150°) |
| Comparison Example 1 | 10 | 0.8 × 10⁸ | 1.2 |
| Test Example 1 | 30 | 1.2 × 10⁸ | 1.2 |
| Test Example 2 | 80 | 1.5 × 10⁸ | 1.4 |
| Test Example 3 | 120 | 3.3 × 10⁸ | 1.5 |
| Test Example 4 | 400 | 8.2 × 10⁸ | 2.4 |
| Test Example 5 | 700 | 12.0 × 10⁸ | 3.0 |
| Comparison Example 2 | 800 | 14.0 × 10⁸ | 4.0 |

Young's modulus is an indicator of hardness (elasticity) in a static condition. The larger its value, the harder is the cleaning layer shown to be. The storage modulus is an indicator of hardness (elasticity) in a dynamic condition. The larger its value, the harder is the cleaning layer shown to be.

As shown in FIG. 2, the cleaning sheet of Comparison Example 1 is the softest, that of Comparison Example 2 is the hardest, and those of Test Examples 1-5 have intermediate hardness values. Each sheet is shown to become softer as temperature increases. The softest and the second softest sheets of Comparison Example 1 and Test Example 1 become softer only a little as temperature increases from 25° C. to 150° C. The hardest and the second hardest of Comparison Example 2 and Test Example 5 become significantly softer as temperature is increased (becoming ⅓ in the case of Test Example 5 and ¼ in the case of Comparison Example 2).

The cleaning sheets of Test Examples and Comparison Examples were used to clean the tip parts of probes by setting the environmental temperatures at 25° C. and 150° C. and using an apparatus as shown in FIG. 3 under the conditions shown in Table 3.

TABLE 3

| | With aluminum debris |
|---|---|
| Probes | attached to tip parts |
| Number of cleaned probes | 100 for each example |
| Depth of penetration by probe from surface | 100 μm |
| of cleaning layer | |
| Frequency of contact | 20 times |

Results of the test are shown in Table 4.

TABLE 4

| | Cleaning effect | Cleaning effect | Wear |
|---|---|---|---|
| | (25° C.) | (150° C.) | on probe |
| Comparison Example 1 | 74/100 | 55/100 | Absent |
| Test Example 1 | 92/100 | 90/100 | Absent |
| Test Example 2 | 100/100 | 93/100 | Absent |
| Test Example 3 | 100/100 | 100/100 | Absent |
| Test Example 4 | 97/100 | 100/100 | Absent |
| Test Example 5 | 92/100 | 100/100 | Absent |
| Comparison Example 2 | 65/100 | 90/100 | Absent |

In FIG. 4, cleaning effect means the number of probes (out of 100 probes) that could be cleaned. As shown in FIG. 4, the cleaning effect depends significantly on the viscoelastic properties of the cleaning layer.

As a practical matter, it is necessary to be able to clean 90 (or preferably 93) out of 100 probes without wearing them down both in the cleaning environments of 25° C. and 150° C. According to the results of Table 4, it is only Test Examples 1-5 that satisfy this requirement. Table 4 also shows that the cleaning layers with favorable viscoelastic characteristics are Test Examples 2-4.

What is claimed is:

1. A probe cleaning sheet for removing foreign objects attached to tip part of a probe, said probe cleaning sheet comprising:
a plastic sheet having a flat and even surface and a uniform thickness; and
a cleaning layer formed on the surface of said plastic sheet, the cleaning layer having a flat and even surface and a uniform thickness, said cleaning layer having viscoelastic properties.

2. The probe cleaning sheet of claim 1 wherein said cleaning layer has Young's modulus of 30 MPa or more and 700 MPa les less, storage modulus at 25° C. of 1.2×10⁸ dyn/cm² or more and 1.2×10⁹ dyn/cm² or less, and value of storage modulus at 25° C. 1.2 or more and 3.0 or less times the value of storage modulus at 150° C.

3. The probe cleaning sheet of claim 1 wherein said cleaning layer has Young's modulus of 80 MPa or more and 400 MPa les less, storage modulus at 25° C. of 1.5×10⁸ dyn/cm² or more and 8.0×10⁸ dyn/cm² or less, and value of storage modulus at 25° C. 1.4 or more and 2.4 or less times the value of storage modulus at 150° C.

4. The probe cleaning sheet of claim 1 wherein said cleaning layer comprises silicon rubber.

5. The probe cleaning sheet of claim 1 wherein said cleaning layer has thickness of 50 μm or more and 300 μm or less.

6. The probe cleaning sheet of claim 1 wherein said plastic sheet has thickness of 50 μm or more and 188 μm or less and thermal shrinkage ratio of 2% within the range of 25° C. or more and 150° C. or less.

7. The probe cleaning sheet of claim 1 further comprising a layer of adhesive agent formed on a back surface of said plastic sheet.
